(19) United States
(12) Patent Application Publication
(10) Pub. No.: US 2020/0347990 A1
(43) Pub. Date: Nov. 5, 2020

(54) GREASE MANIFOLD SYSTEM

(71) Applicant: GJR Meyer Service, Inc., Corpus Christi, TX (US)

(72) Inventor: Noel McKim, Corpus Christi, TX (US)

(73) Assignee: GJR Meyer Service, Inc., Corpus Christi, TX (US)

(21) Appl. No.: 16/866,200

(22) Filed: May 4, 2020

Related U.S. Application Data
(60) Provisional application No. 62/842,793, filed on May 3, 2019.

(51) Int. Cl. F16N 29/02; F16N 11/08; F16N 25/00

(52) U.S. Cl. CPC F16N 29/02; F16N 11/08; E21B 34/02; F16N 2250/04; F16N 2270/70; F16N 25/00

(57) ABSTRACT

A greasing system may use a programmable logic controller. The programmable logic controller, grease pumps, and power system control grease flow into two or more fracked valves on a well are maintained outside of the red zone of the well. The programmable logic controller includes a display that is adaptable to include information related to individual frak valves such as the associated well, the type of valve greasing utilized such as pressure based greasing or stage based greasing and also may include upper and lower limits on pressure and/or amount of grease utilized.

### CROSS-REFERENCE TO RELATED APPLICATIONS

This application claims priority to U.S. Provisional Patent Application No. 62/842,793 that was filed on May 3, 2019.

### BACKGROUND

There are problems when increasing the number of valves used on frac locations. The valves may include frac zipper, frac manifold, well tree valves, etc. These are generally surface valves that control where the fluid is flowing on the surface as opposed to the downhole valves. They could be high-pressure gate valves involved in the fracking process or they could be a blowout preventer stack involved in well control.

An issue in a frac type application is that most if not all of the surface valves, such as those described above, have to be frequently greased, in some instances on an hourly basis. In a recent improvement in the industry multiple valves may be connected to a single manifold where each valve may be greased independently. However, generally each valve must be turned on or off by hand. Additionally, in order to keep personnel out of the danger zone which is generally defined as being within 100 feet of the well valves, thousands of feet of high pressure hoses are deployed between the manifold and the frac valves to be greased. Each hose is in turn an additional hazard to anyone that must enter the danger zone and further is a potential source of failure.

### SUMMARY

In an embodiment of a frac valve greasing system a programmable logic controller, a grease supply, a grease pump, a high flow manifold, and a flow meter, are provided. The grease pump supplies grease from the grease supply to the high flow manifold. The high flow manifold has at least one inflow port connected to the grease pump. In certain systems a second or third response may be utilized. In some instances additional response may merely provide redundancy in other systems additional grease pumps may provide additional flow volume at pressure. While in some instances the grease pump or pumps are able to function at lower pressures usually the grease pump or pumps provide grease at, at least 15,000 psi in order to overcome pressure within the frak valve.

The high flow manifold has at least 2 exit ports. A grease control valve is fluidly connected to each exit port. In some instances a short tube or hose may be connected between the grease control valve and each exit port. The grease control valve is in turn connected to a grease hose. In many cases the grease hose is on a hose reel, a spool, or simply stored on the frak valve greasing system skid. Each grease hose provides a fluid pathway between the grease control valve and a frac valve. A programmable logic controller is provided to actuate the grease pump and each grease control valve according to a preset grease pumping profile. Upon activating the system valve identification parameters are provided to the programmable logic controller. Then any variables such as which grease pumping profile is to be used for each valve is provided to the programmable logic controller. Generally, a first greasing parameter is a pressure based greasing parameter and a second greasing parameter is a stage based greasing parameter. The programmable logic controller then begins greasing each valve upon receiving signals from connected sensors to actuate the grease pump and each grease control valve according to its preset routines. The programmable logic controller may then deactivate the grease pump and/or depressurize the system upon reaching a preset grease amount. In most instances check valves are include in the system between the frak valves and the high flow manifold to prevent fluid or pressure in the frak valve from entering the high flow manifold.

Advantages and other features of the invention will become apparent from the following drawing, description and claims.

### BRIEF DESCRIPTION OF THE DRAWINGS

FIG. 1 depicts a skid mounted greasing unit having a programmable logic controller.

FIG. 2 depicts an initial configuration screen displayed by the programmable logic controller.

FIG. 3 is the label stack screen reached by activating the label stack GUI button from FIG. 2.

FIG. 4 is a job configuration screen reached by activating the job configuration GUI button from FIG. 2.

FIG. 5 is a configuration page that is displayed upon selecting a 3 well job on the configuration page of FIG. 3.

FIG. 6 is the greasing configuration screen that is displayed upon selecting a well, such as well 1, on the configuration page of FIG. 5.

FIG. 7 is an alternative embodiment of a pressure based greasing configuration screen.

FIG. 8 is an alternative embodiment of a stage based greasing configuration screen.

FIG. 9 is an alarm messages screen.

FIG. 10 depicts an embodiment of a wellpad with multiple wells incorporating a grease manifold system.

FIG. 11 depicts a pump lubrication system.

### DETAILED DESCRIPTION

The description that follows includes exemplary apparatus, methods, techniques, or instruction sequences that embody techniques of the inventive subject matter. However, it is understood that the described embodiments may be practiced without these specific details

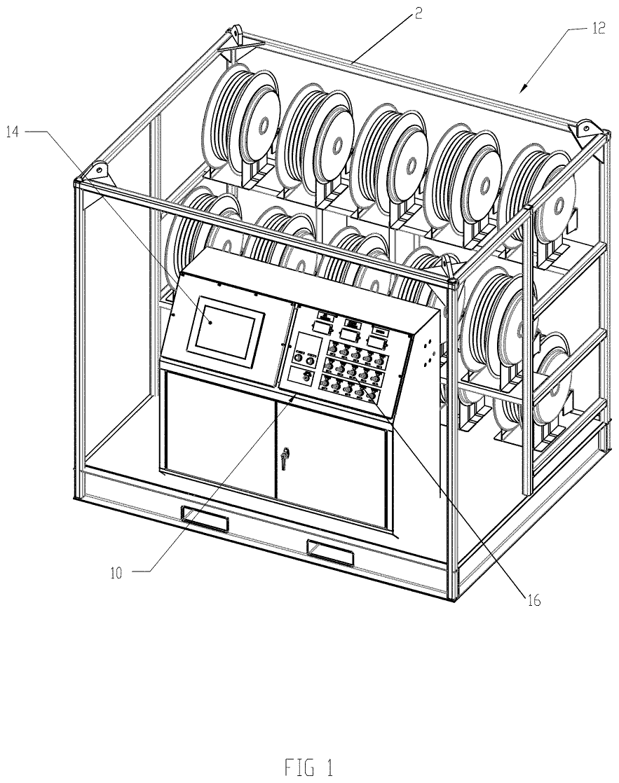

FIG. 1 is a skid unit 2 that incorporates a programmable logic controller 10, a multi-reel system 12, a display 14, and a series of user operable switches 16. The display 14 may simply be a display or it may be a touchscreen. The programmable logic controller 10 receives input from pressure transducers near each valve that is being greased on the wellhead where each pressure transducer is associated with one reel on the multi-reel system 12. Programmable logic controller 10 also receives input from a pressure transducer and flow meter near a pump where the pump supplies grease to a high flow manifold on the skid unit 2. The high flow manifold is connected to each of the reels on the multi-reel system 12 with a valve operable by the programmable logic controller 10 between the high flow manifold and each of the reels on the multi-reel system 12. Generally, a high flow manifold is a manifold that has less than a 10% pressure drop across the manifold.

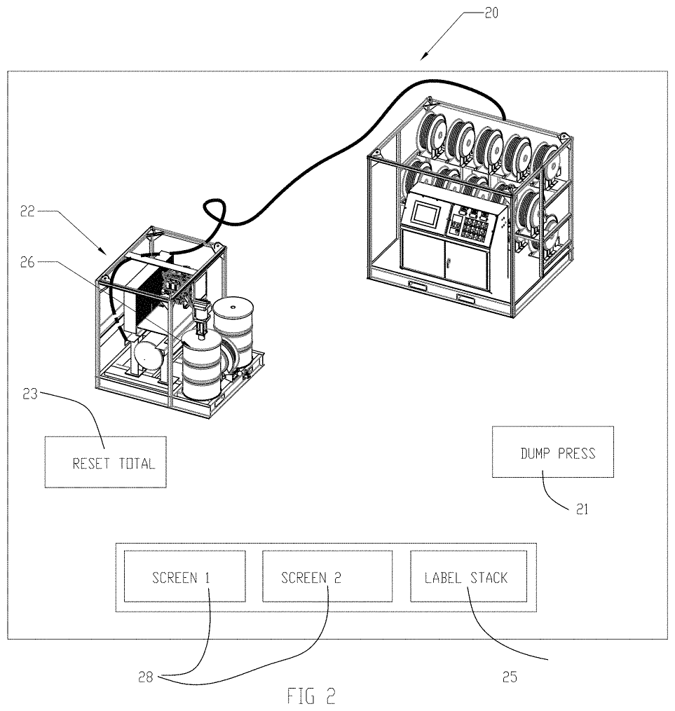

FIG. 2 is the initial configuration screen 20 displayed on the display 14 by the programmable logic controller 10. The initial configuration screen 20 in FIG. 2 is the main screen and includes screen transfer options. FIG. 2 also displays a pump unit 22 mounted on a trailer or skid 24 along with the grease source 26. The initial configuration screen 20 includes screen transfer options including a job configuration graphic user interface, or GUI, button 28, a dump valve pressure GUI button 21 configured to initiate an automatic system pressure dump for pumps, the various manifold valves, and lines, and a reset Grease totals GUI button 23 allows the user to reset the system grease totals. Generally, the GUI button 21 is a shut down cycle or rig down to verify there is no pressure in any of valves that can be utilized as an emergency shut off. The label stack GUI button 25 allows the user to rename various components of the greasing system in order to have system labels conform to the wellsite labels and names in order to avoid confusion at the wellsite.

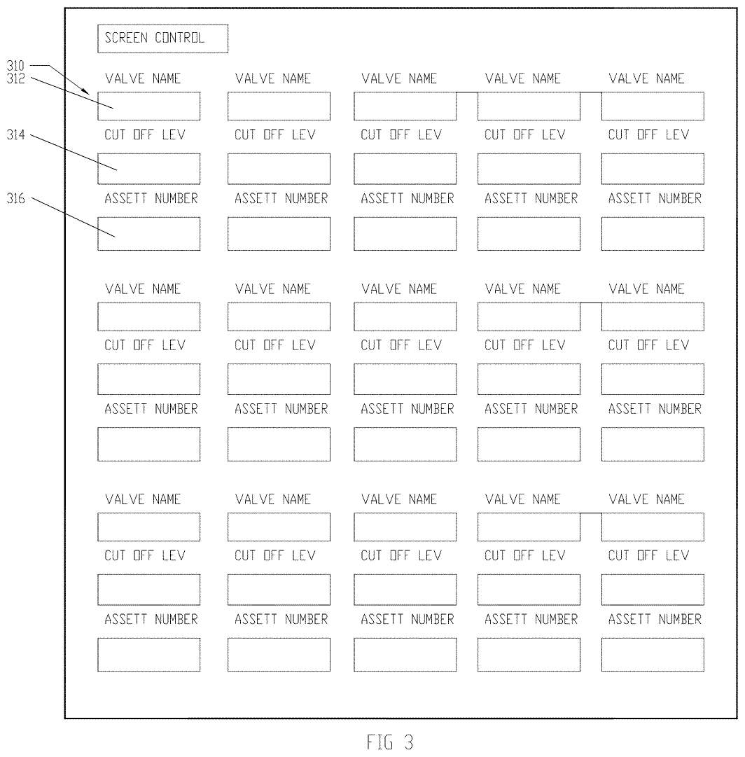

FIG. 3 is the label stack screen reached by activating the label stack GUI button 25 from FIG. 2. In this instance there are 15 sets of GUI buttons displayed. The number of GUI buttons is arbitrary and more or less may be used. In the preferred embodiment each set of GUI buttons 1 through 15 is associated with a particular valve controlling output from a port on the manifold. Each valve 1-15 then has a fluid pathway through a hose on a hose reel to a particular Frak valve that requires greasing. Valve label 1 GUI button 310 includes a field 312 may be manipulated by the user typically by keyboard to include an identifier with a valve in the field or Frak valve that is greased via valve 1. A second valve 1 cut off GUI button 314 may be manipulated by the user to include a maximum amount of grease pumped through valve 1 to the Frak valve is greased via valve 1. The amount of grease pumped may be displayed in pounds, kilograms, gallons, or other measuring system. Finally, a third valve 1 asset number GUI button 316 may be manipulated by the user to include a valve serial number or other valve identifier in order to track the service life of the particular valve. Each of the 15 sets of GUI buttons includes the valve label, the valve cutoff amount, and the valve asset number. Each of the 15 sets of GUI buttons may include additional information or less information as the user desires.

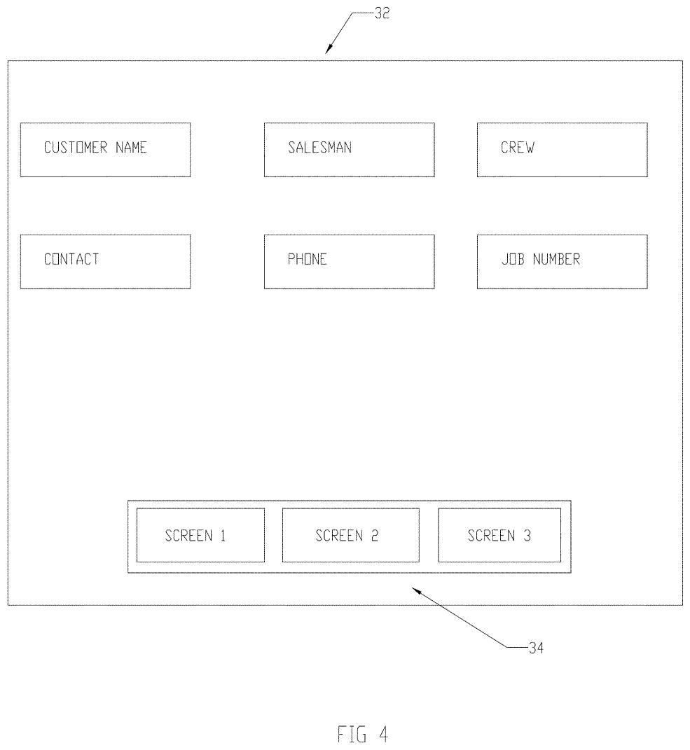

FIG. 4 is a job configuration screen 32 and allows for entry of job specific information such as: customer name, company man name, company man phone, company man email, salesman, day tech, night deck, grease type, fracked crew, wellhead company, and other job specific information. FIG. 3 also includes a number of GUI selection buttons 34 to allow the operator to configure the programmable logic controller for the specific number of wells whether it's a single, 2 well, 3 well, 4 well, or other size job.

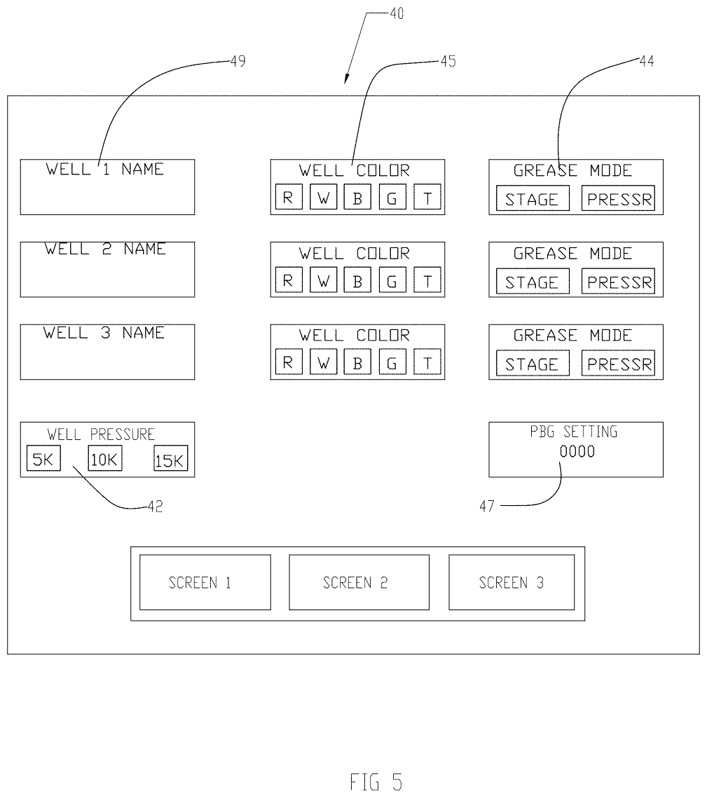

FIG. 5 is a configuration page 40 that is displayed upon selecting a 3 well job on the configuration page of FIG. 3. The configuration page 40 is utilized to apply particular information for each specific well and the valves associated with that well, such as well name which is associated with GUI button 49 and the physical color, color scheme, or pattern of the wellhead which is associated with GUI button 45 to allow for visual identification of a particular well. Configuration page 40 also allows selection of either stage based or pressure based greasing programs. In this example FIG. 5 includes 3 wells. FIG. 5 shows that wellhead pressure is input at GUI interface 42 to provide parameters to the pumping system. The wellhead pressure input may be preset, or user settable. The pressure based drilling, or PBG, mode is a pressure based setting and may be selected at GUI interface 44. PBG is a pressure based greasing program that utilizes differential pressure. The grease cycle starts automatically when wellhead pressure passes a preset limit indicating pressure pumping has started. In the example shown a 0000 pound pressure differential is shown in the PBG mode GUI button 47. However, as an example if 1000 were input into the PBG mode Gui button 47, and if the wellhead pressure was 5000 psi the system would supply grease at 6000 psi. The PBG mode is user selectable using GUI button 44 to switch between pressure base greasing and stage based greasing. Each frac valve's specifications, size of proppant, treating pressure, or the maximum amount of grease per cycle may be included in various fields for each frak valve. In addition to or in place of pressure, stop or start cycles may be commanded by various other signals such as flow signals or remote triggers from pump trucks or wireline units.

If stage based greasing is selected when the system sees a pressure increase on the wellhead and then a pressure decrease, although not necessarily to zero but to a preset level, one stage has been completed. Upon completion of a stage and once the wellhead is at the lower pressure grease is pumped to the desired valves grease. Grease may be applied individually to a valve in stage based mode by pressing a GUI button, joystick, or button. The system uses wellhead rating and a preset maximum volume of grease in order to prevent over greasing a particular valve.

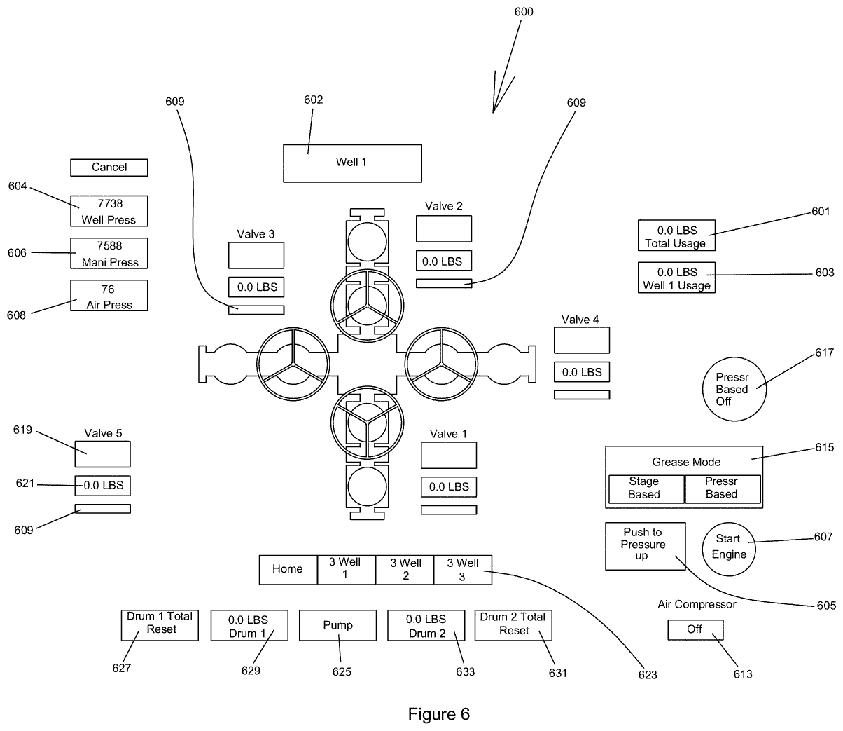

FIG. 6 is the greasing configuration screen 600 showing the wellhead name 602 and may be toggled between a stage based greasing profile and a pressure based greasing profile by using GUI button 615. Greasing configuration screen 600 may be switched between the various wells by toggling GUI button 623, which in this configuration depicts being able to switch between the home screen and three wells, including the current well 1. In FIG. 6 GUI button 615 shows toggled to the stage based greasing profile and indicator 617 shows that pressure based greasing is off. The greasing configuration screen 600 typically displays pressures including the wellhead pressure 604, the manifold pressure 606, and air pressure 608. Also displayed is the total grease usage for the job 601, and the total grease usage for the wellhead 603. Additionally, the greasing configuration screen may include a GUI selection button that toggles between a pressure up GUI button 605 and when the system is in operation and is pressured up becomes the emergency relief valve. GUI selection button 607 is provided to start and stop an air compressor that drives the grease pump. Indicator 611 is provided to show whether the air compressor is on or off. The greasing configuration screen 600 may include a number of GUI toggles 609 that can be used to independently select and grease a particular valve. Depending upon the well requirements the various valves in a wellhead, in FIG. 6 well 1 is depicted as having 5 frack valves, the 5 frac valves may be individually set for pressure based or stage based greasing or may be group set to all have stage based or pressure base degreasing. Each of the 5 frac valves is shown as having a set of fields for each of the 5 frac valves, for instance frac valve 5 includes a blank screen 619 for notes related to frac valve 5. The blank screen 619 may be color coded as well in order to identify frac valve 5. Field 621 displays the amount of grease that has been pumped into valve 5. GUI button 625 toggles between grease pump 1 and grease pump 2 in a two pump system. GUI button 627 resets the amount of grease displayed by indicator 629. Indicator 629 identifies the drum or grease reservoir being tracked and displays the amount of grease pumped out of or remaining in the identified reservoir. GUI button 631 resets the amount of grease displayed by indicator 633. Indicator 633 identifies the drum or grease reservoir being tracked and displays the amount of grease pumped out of or remaining in the identified reservoir.

It is envisioned that an alarm may be triggered upon the system noting preset parameters have been reached. For instance if a valve is taking more grease than normal based on an average of previous grease usage an alarm may be triggered indicating that a particular valve is worn and needs to at least be inspected.

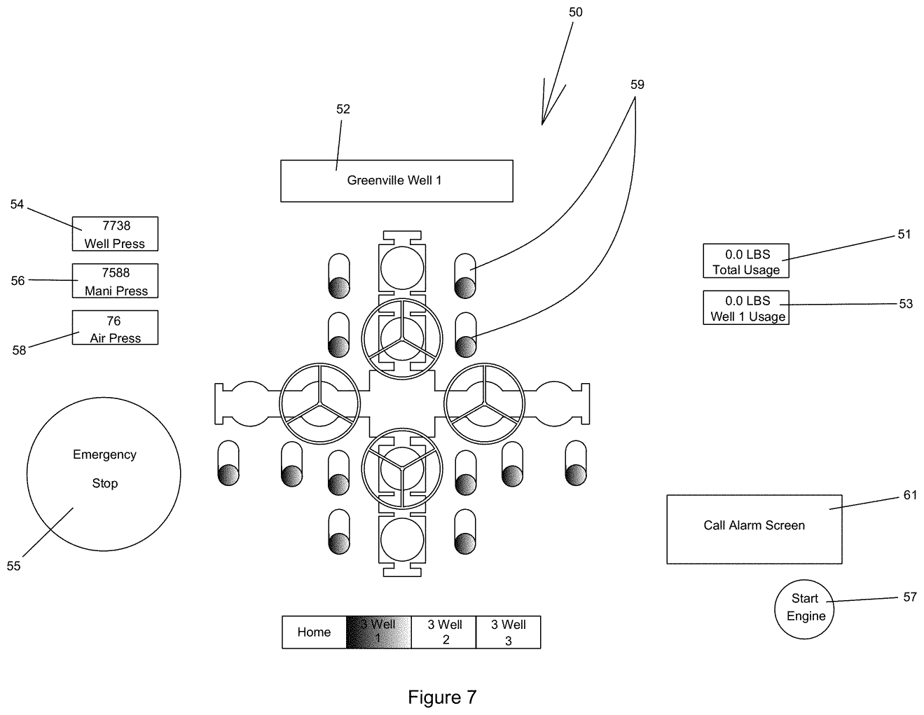

FIG. 7 is an alternative embodiment of a pressure based greasing configuration screen 50 showing the wellhead name 52. The pressure based greasing configuration profile typically displays pressures including the wellhead pressure 54, the manifold pressure 56, and air pressure 58. Also displayed is the total grease usage for the job 51, and the total grease usage for the wellhead 53. Additionally the pressure based greasing configuration screen may include a GUI selection button to operate an emergency relief valve 55, GUI selection button to start and stop an air compressor 57, and a GUI selection button 61 to access the alarm screen. Additionally, the pressure based greasing configuration screen 50 may include a number of GUI toggles 59 that can be used to independently select and grease a particular valve usually graphically depicted with the GUI toggle.

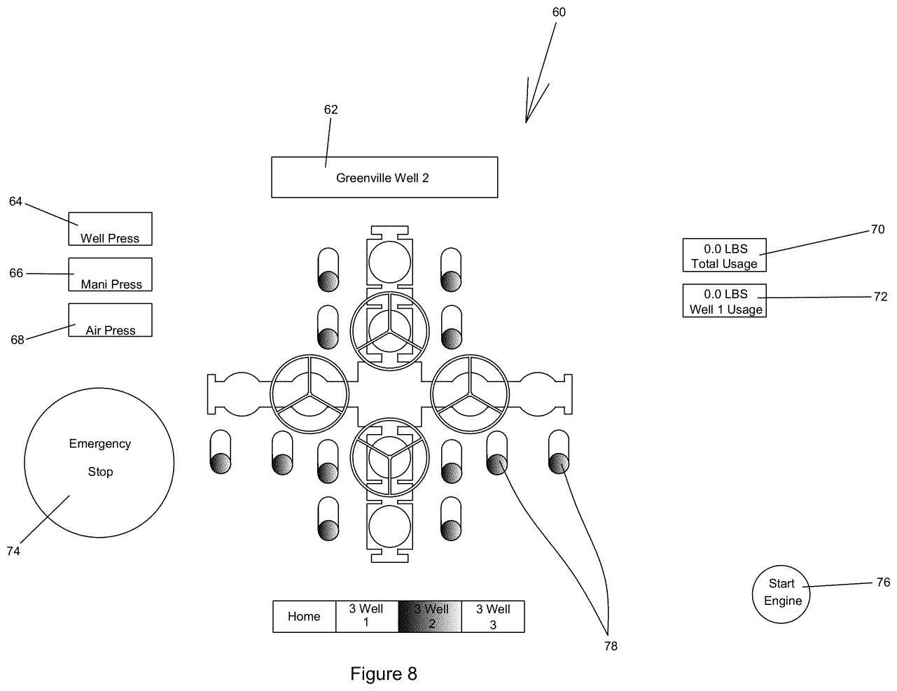

FIG. 8 is an alternative embodiment of a stage based greasing configuration screen 60 showing the wellhead name 62. The pressure based greasing configuration profile typically displays pressures including the wellhead pressure 64, the manifold pressure 66, and air pressure 68. Also displayed is the total grease usage for the job 70, and the total grease usage for the wellhead 72. Additionally, the pressure based greasing configuration screen may include a GUI selection button to operate an emergency relief valve 74, and a GUI selection button to start and stop an air compressor 76. A GUI selection button to access the alarm screen may be included if desired. Additionally, the pressure based greasing configuration screen 60 may include a number of GUI toggles 78 that can be used to independently select and grease a particular valve usually graphically depicted with the GUI toggle.

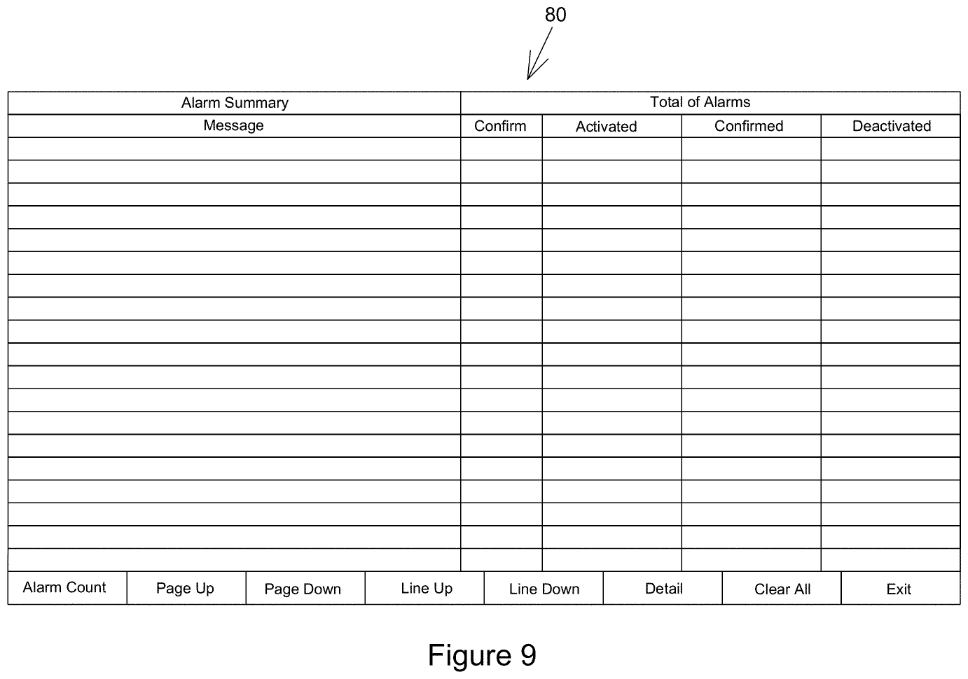

FIG. 9 is the alarm screen 80, referred to previously in FIG. 6. The alarm screen 80 provides a message summary of the alarm, a count of the alarms, when an alarm is activated, whether or not and when an alarm is deactivated. The alarm screen 80 also provides a GUI button to access additional details of a particular alarm and a GUI button to clear alarms.

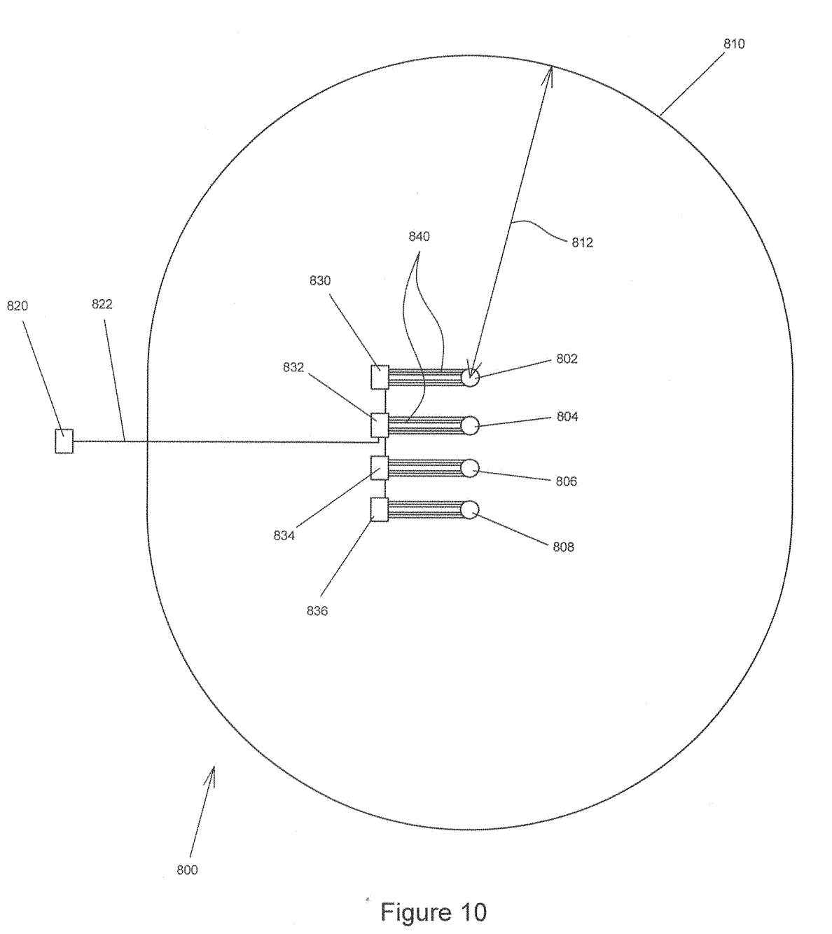

FIG. 10 depicts an embodiment of the grease manifold system 800 that would incorporate the above described control system. The grease manifold system 800 is depicted set up on a first wel1,802, a second well 804, a third well 806, and a fourth well 808. As depicted the wells 802, 804, 806, and 808 have a red zone 810 at some distance shown by the arrow 812 from the wells. The red zone 810 is a danger or high hazard area where anyone within the red zone 810 may be subject to flammable or otherwise hazardous materials and high pressure vessels. In this instance a skid 820 having an air compressor, a high-pressure pump, and grease source is located outside of the red zone 810. A single high-pressure tubular or hose 822 is run into the red zone 810 and is connected to a first multi-reel system 830, a second multi-reel system 832, a third multi-reel system 834, and a fourth multi-reel system 836. Each multi-reel system 830, 832, 834, and 836 is in turn connected to its respective well in this case well 802, 804, 806, and 808. In some instances a single multi-reel's system may be connected to multiple wells for instance a multi-reel system may incorporate 10 reels where five reels are connected to a first well and five reels are connected to a second well. In some instances more than one multi-reel systems may be connected to a single well when a particular well has more valves than a single multi-reel system has connections. In FIG. 10 hose or tubular 822 provides sufficient grease flow with a 10% or less pressure drop over its length to provide grease to multiple manifolds within the red zone 810 in order to keep the grease lines 840 between the various multi-reel systems and the wells as short as possible, preferably less than 20 feet each. In some instances a master programmable logic controller that incorporates the system described above may remain outside the red zone 810 on skid 820. In other instances each multi-reel system 830, 832, 834 and 836 may be provided with its own programmable logic controller incorporating the system described above for the particular well or valves that the multi-reel system is connected to. In another embodiment anyone of the multi-reel systems 830, 832, 834 or 836 may be provided with the master programmable logic controller controlling all wells within the system.

The data and actions can be monitored and stored locally or uploaded into the cloud. This cloud can be loaded in databases or storage files for failure analysis, predictive analysis or artificial intelligence decision making. The communication system can be used either through wireless or cellular type communication to store transmit data as well as to monitor or even remotely control the operation off site.

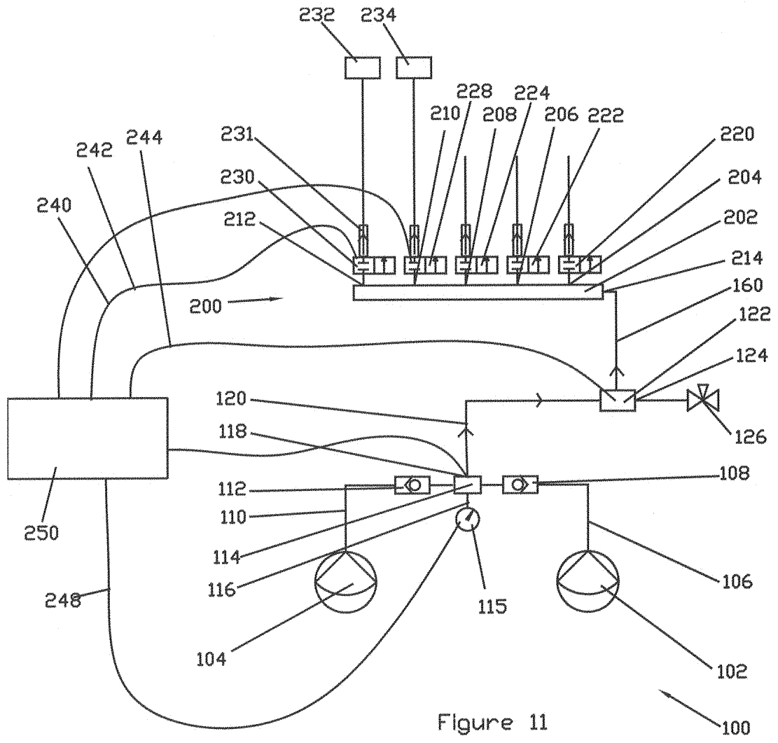

The system depicted in FIG. 11 has a pump side 100 and a high flow lubricant manifold side 200. The pump side shows a first pump 102 and a second pump 104. Preferably each pump is pneumatically operated having an approximately 100 psi air pressure input that drives the pump to supply lubricant at approximately 15,000 psi. The output pressure of the pneumatic pump depends upon the input air pressure and area of the pneumatic piston as compared to the area of the output piston typically pneumatic pumps provide output pressure at between 10,000 psi and 20,000 psi, although this case the optimal pressure is 15,000 psi. The output of the first pump 102 flows through line 106 into check valve 108 while the output of the second pump 104 flows through line 110 to check valve 112. Each of the check valves 108 and 112 allow lubricant to flow out of its respective pump but does not allow lubricant or other fluid to flow back towards the pump. As the fluid flows out of either pump 102 or 104 it flows into a junction in this case a four-way junction 114. In addition to the output from check valve 108 and 112 the four-way junction 114 has a port for a pressure gauge 116 and the output port 118. The output port 118 flows into line 120 and is connected to a three way valve 122. The three way valve 122 has input from line 120 and has a port 124 connected to a valve 126. The valve 126 can be used to bleed pressure from the system, to connect via a hose (not shown) directly to the wellhead valve that needs to be lubricated, or may connect to another set of lubricant pumps. Additionally the three way valve 122 has an output line 160. The output line 160 is connected to the high flow lubricant manifold 202. The high flow lubricant manifold has a number of ports such as port 204, 206, 208, 210, 212, and 214. In this instance for 214 is an input port and is connected to line 160 from the three way valve 122 and provides lubricant to an internal cavity within high flow lubricant manifold 202. The lubricant then flows into the internal cavity within high flow lubricant manifold 202. Each of the ports 204, 206, 208, 210, and 212 is an output port and is in fluid communication with the internal cavity within high flow lubricant manifold 202. While in this instance five ports are shown more ports or fewer ports may be provided as required. Each output port 204, 206, 208, 210, and 212 is connected to a greasing valve, such as greasing valves 220, 222, 224, 226, 228, and 230 that control lubricant flow from the high flow lubricant manifold 202 through the particular port and into the wellhead valve needing lubrication. In this instance each of the greasing valves such as valve 220 is an electromechanical or pneumatic valve such as a solenoid actuated as previously described to open a fluid path allowing fluid to flow from the high flow lubricant manifold 202 and into the frac valves 232 or 234 requiring lubrication. In most instances there are two or more frak valves on each wellhead. Connected between the frak valves such as frak valve 232 and the high flow lubricant manifold ports such as port 212 is a safety valve 231 to prevent the flow of fluid or pressure from frak valve 232 into high flow manifold 202.

The programmable logic controller 250 may actuate greasing valves such as greasing valves 228 or 230 via line 240 or 242. The programmable logic controller 250 may actuate three way valve 122 via line 244. The programmable logic controller 250 may actuate pump 114 via line 246 Information is supplied to programmable logic controller, such as pressure from pressure sensor 115 via line 248.

The methods and materials described as being used in a particular embodiment may be used in any other embodiment. While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for controlling a frac valve greasing system comprising:
a programmable logic controller, a grease supply, a grease pump, a high flow manifold, and a flow meter,
wherein the grease pump supplies grease from the grease supply to the high flow manifold,
wherein the high flow manifold has at least 2 exit ports and at least 1 inflow port,
further wherein a grease control valve is connected to each exit port and to a grease hose, each grease hose provides a fluid pathway between the grease control valve and a frac valve,
inputting valve identification parameters into the programmable logic controller, providing greasing parameters for each valve to the programmable logic controller,
wherein a first greasing parameter is a pressure based greasing parameter and a second greasing parameter is a stage based greasing parameter,
allowing the programmable logic controller to actuate the grease pump and each grease control valve.

2. The method of claim 1 further comprising,
allowing the programmable logic controller to deactivate the grease pump upon the system exceeding a preset grease amount.

3. The method of claim 1 further wherein the grease pump is capable of supplying grease at a pressure of at least 15,000 PSI.

4. The method of claim 1 further comprising, check valves to prevent flow from the frac valve to the high flow manifold.
